(19) United States
(12) Patent Application Publication
(10) Pub. No.: US 2007/0274381 A1
(43) Pub. Date: Nov. 29, 2007

(54) Wireless Multimedia Communication Method

(75) Inventors: Haitao Li, Beijing (CN); Jifeng Li, Kanagawa (JP)

Correspondence Address: STEVENS, DAVIS, MILLER & MOSHER, LLP, 1615 L. STREET N.W., SUITE 850, WASHINGTON, DC, 20036, US

(73) Assignee: MATSUSHITA ELECTRIC INDUSTRIAL CO., LTD., OSAKA (JP)

(21) Appl. No.: 11/575,826

(22) PCT Filed: Sep. 22, 2005
(86) PCT No.: PCT/JP05/17508

§ 371 Date: Mar. 22, 2007

(30) Foreign Application Priority Data
Sep. 24, 2004 (CN) 200410011879.6

(51) Int. Cl. H04N 11/04

(52) U.S. Cl. 375/240.01

(57) ABSTRACT

A wireless multimedia communication method for improving wireless video transmission quality by using physical layer channel status information (CSI) in a video application layer. In this method, the transmitting end decides the maximum transmission rate (Rₘₐₓ) of the system based on both SNR information of receiving antennas fed back from the receiving end and a bit error rate required by the system. At the same time, a hierarchical encoding method is used, in the video application layer, to divide a bit stream into a basic layer and an expansion layer. In a case of employing an FGS encoding method, the transmission is caused to start with the basic layer, and the number of bits is increased in the expansion layer just until the bit rate of the video stream has become below Rₘₐₓ. In a case of employing an encoding method based on a signal-to-noise ratio hierarchy, spatial hierarchy or time hierarchy, if Rₘₐₓ is large enough to accommodate both the basic and expansion layers at the same time, both are transmitted; otherwise, only the basic layer is transmitted.

### TECHNICAL FIELD

The present invention particularly relates to a wireless multimedia communication method employing multi-antenna orthogonal frequency division multiplexing (OFDM).

### BACKGROUND ART

Wireless multimedia communication that merges wireless communication, the Internet and multimedia is a field where the growth in the communication operation is expected now and in the future. The development of the next-generation wireless communication system is therefore necessary in order to satisfy the requirements for wireless multimedia and high-speed data transmission. Out of these techniques, MIMO-OFDM wireless transmission technique which combines multi-antenna input and output (MIMO) and orthogonal frequency division multiplexing (OFDM) broadly draws attention.

The MIMO-OFDM technique which combines MIMO and OFDM has features of both MIMO and OFDM. Namely, with the MIMO-OFDM technique, frequency selecting type MIMO fading channels can be broken down into groups of flat fading channels using OFDM modulation, and the system capacity can be increased using MIMO. Therefore, the MIMO-OFDM technique is suitable for multimedia operation such as high transmission rate audio and video.

In wireless multimedia communication, wireless transmission of video is difficult compared to data and audio. With video coding algorithms employing motion compensation, a large number of frames relate to their previous frames. Errors of a given frame are conveyed to subsequent several frames, and thereby serious deterioration in transmission quality is invited. A video frame has to be received within a fixed duration period of time due to the real-time characteristics of video. High bit rate, low error rate and low time delay are requirements peculiar to video communication. In the conventional communication network, the protocol of each layer is set independently, and in the case of wireless video, the video application is independent from the transmission channel.

However, problems such as shadowing, multi-path fading and other interference invite deterioration in received video quality under wireless propagation environment. In order to reduce the error rate, it is necessary for the coded bit rate of the video stream to support the channel transmission bit rate. In order to achieve this object, there is a problem that complex buffers and error correction mechanisms are necessary at the physical layer and the media access control (MAC) layer in order to make a wireless channel have a fixed bit rate and high reliability like a wired channel.

Typically, video application has strict time delay requirements, and therefore, even when the channel conditions are good, the transmission quality is not always guaranteed. Out of techniques advocated in the related art for increasing the multimedia transmission quality, a forward error correction (FEC) mechanism increases code redundancy, and an automatic repeat request (ARQ) mechanism is superior to FEC in performance, but invites time delays. In these techniques, the physical layer and the video application layer are independent of each other.

### DISCLOSURE OF INVENTION

### Problems to be Solved by the Invention

It is therefore an object of the present invention to provide a wireless multimedia communication method which is different from those of the related art where layers are provided independently, and capable of increasing wireless video transmission quality by using physical layer channel state information (CSI) at a video application layer.

### Means for Solving the Problem

A wireless multimedia communication method of the present invention has the steps of: scalability coding a multimedia video stream and dividing the multimedia video stream into a base layer and an enhancement layer based on a specific scalable coding scheme; determining at an application layer whether or not a maximum transmission rate is larger than a current channel transmission rate upon transmission at a physical layer based on current channel transmission rate information acquired from the physical layer; and when the maximum transmission rate is less than the current channel transmission rate, ending processing, and, when the maximum transmission rate is larger than the current channel transmission rate, and, when the specific scalable coding scheme is a first scalable coding scheme, starting transmission from the base layer and increasing bits at the enhancement layer until immediately after the current channel transmission rate of the video stream falls below the maximum transmission rate, and, when the specific scalable coding scheme is a second scalable coding scheme, and, if the maximum transmission rate can simultaneously accommodate the base layer and the enhancement layer, transmitting the base layer and the enhancement layer, and, if the maximum transmission rate cannot simultaneously accommodate the base layer and the enhancement layer, transmitting only the base layer.

### ADVANTAGEOUS EFFECT OF THE INVENTION

According to the present invention, which is different from the related art where layers are provided independently, it is possible to increase transmission quality of wireless video by using physical layer channel state information at the video application layer.

### BRIEF DESCRIPTION OF THE DRAWINGS

FIG. 1 is a block diagram showing a configuration of a MIMO OFDM wireless multimedia communication system according to an embodiment of the present invention; and

FIG. 2 is a flowchart of a cross layer joint method according to the embodiment of the present invention.

### BEST MODE FOR CARRYING OUT THE INVENTION

### Embodiment

Embodiment of the present invention will be described in detail below with reference to the accompanying drawings. The embodiment described below is provided for description and by no means limits the scope of the present invention.

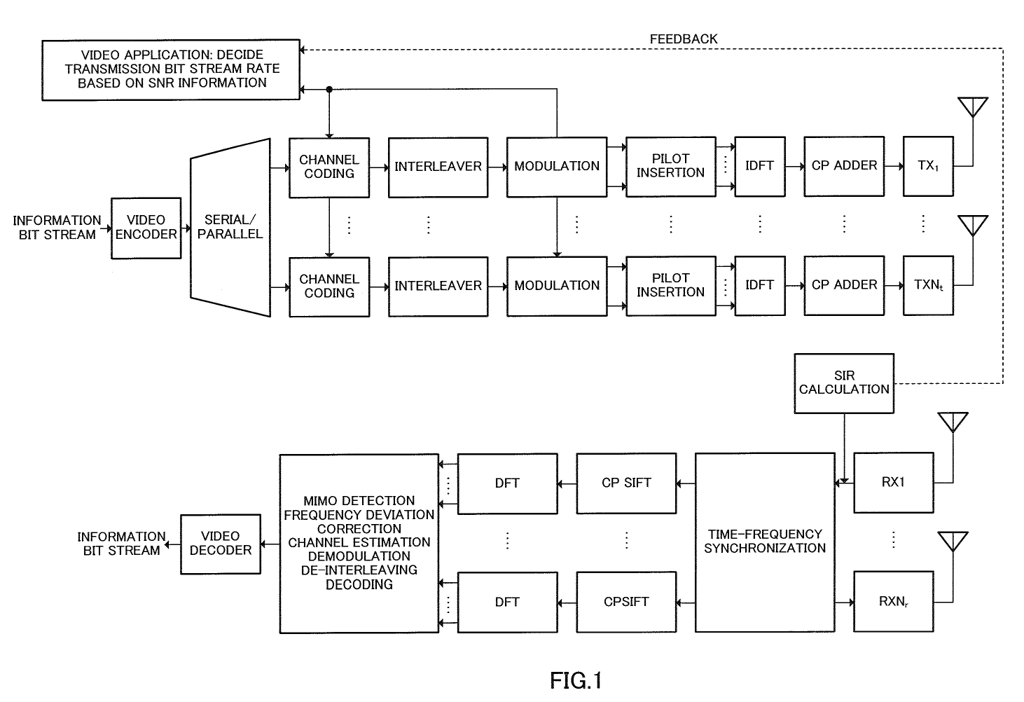

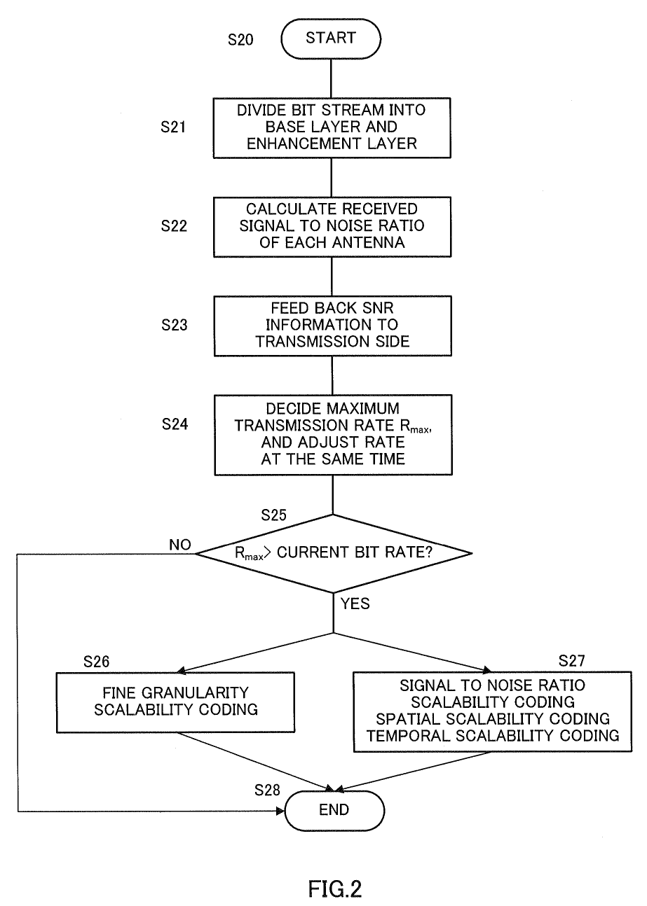

The idea of the present invention is to decide a transmission bit rate using channel information acquired through feedback on the transmission side, and the embodiment of the present invention will be described in detail below using combination of FIG. 1 and FIG. 2.

In step 1, a multimedia bit stream is scalability coded on the transmission side (S21). Namely, the video application layer divides the bit stream into a base layer and enhancement layer using a scalable coding scheme such as a signal to noise ratio, spatial, temporal and fine granularity.

With the scalable coding technique, a video sequence is coded to a plurality of bit streams (layers), where the importance and bit rate of each layer is variable. The video reception quality is decided from the number of the received base layers and enhancement layers. The base layer is the most important and includes coarse granularity information. The enhancement layer includes enhancement information that may be added to the information of the base layer. The relative importance of the enhancement layer decreases in accordance with an increase of a distance from the base layer. The base layer has independence and can be decoded regardless of the success or failure of acquisition of the enhancement layer. On the other hand, the enhancement layer cannot be decoded if there is no information of the base layer and previous enhancement layers. As a result of scalable video coding, the video bit stream is coded at a plurality of bit rates rather than one bit rate. Fading of the wireless channel makes change of the bit rate faster. Therefore, it is necessary to overcome the influence of the fading using the effective mechanism, and the use of scalability coding at the transmission source is one effective method of suppressing coding errors. Scalability coding may be divided into four types of signal to noise ratio scalability coding (SNR Scalability Coding), temporal scalability coding, spatial scalability coding and fine granularity scalability (FGS) coding.

With signal to noise ratio scalability coding, the signal to noise ratio of the transmitted video bit stream quantizes coefficients through proportion. The PSNR (Peak Signal to Noise Ratio) is different between the original video and the video after quantization because of the different quantization accuracy, and therefore this is also referred to as SNR scalable. The base layer is acquired by applying a coarse quantizer to the original image or a converted area. Further, an enhancement layer includes a quantization difference value between the original image and an image reproduced from the original image, and quality better than for the base layer can be acquired using a more precise quantizer.

Moreover, with temporal scalability coding, it is possible to use different frame rates at layers with different content. Normally, at the base layer, coding is carried out using a low frame rate, and at the enhancement layer, coding is carried out using a high frame rate in order to obtain high video quality.

Further, with spatial scalability coding, coding is carried out at a low analytic rate at the base layer, and coding is carried out at a high analytic rate at the enhancement layer. The enhancement layer uses small quantization parameters, and quality is therefore high compared to the base layer.

Further, with fine granularity scalability coding, the above-described scalability coding generates a bit stream formed with some number of layers including some number of enhancement layers after the base layer. This type of encoder is superior in performance compared to an encoder which does not have scalability, but only provides coarse granularity, and when the symbol rate increases with a large discrete width, quality is first improved. With the fine granularity scalability coding, the symbol rate and quality increase little by little. In an extreme state, the fine granularity scalability coding is intrusion coding where the bit stream consecutively improves the quality of the video through each additional bit.

A description is now given taking the H.263+ video stream as an example. H.263+ provides spatial and temporal scalability coding options. When the SNR scalability scheme is selected, the base layer is formed with I frames and P frames. This is the SNR scalable coding scheme, and therefore the enhancement layer is formed with different information between the original image and a quantized image including I frames and P frames. With H.263+, the enhancement layer information is coded to an EI frame or an EP frame corresponding to the I frame or the P frame. Therefore, in the case of transmitting an extended image, the enhancement layer (EI frame or EP frame) corresponding to the base layer (I frame or P frame) is included.

In step 2, the video bit stream is transmitted by the MIMO-OFDM system, channel transmitted, and restored.

FIG. 1 shows the MIMO-OFDM system having Nₜ transmission antennas and Nᵣ reception antennas.

The video bit stream where the information bit stream is video coded is transmitted after being subjected to multiplexing, channel coding, interleaving, modulation, N_{c} point inverse discrete Fourier transform (IDFT) and insertion of cyclic prefix (CP). On the reception side, the received signal to noise ratio of each antenna (normally, the received signal to noise ratio of each antenna is assumed to be the same) is calculated using the training sequence. This reflects the channel state information, and is fed back to the transmission side (S23).

A cross-layer joint is set in step 3.

The physical layer then changes the transmission rate over time in accordance with the current SNR estimated by the receiver. This can be implemented using modulation schemes such as multilevel quadrature amplitude modulation (MQAM) and multi-PSK (MPSK), and coding schemes such as convolution coding, Turbo coding and low density parity coding (LDPC). Further, symbol timing is carried out using a training sequence, and after frequency deviation estimation, correction, CP shifting and N_{c} point discrete Fourier transform (DFT), transmission symbols are restored using an MIMO algorithm such as maximum likelihood estimation, VBLAST and sphere decoding. The video bit stream is then restored after carrying out demodulation, de-interleaving and decoding, and finally the information bits are restored using a video decoder.

On the transmission side, maximum transmission rate Rₘₐₓ for the physical layer on the transmission side is decided in accordance with the acquired SNR information and the bit error rate required by the system (S24). For example, in the case of a system using MPSK modulation, the SNR and Pₑ are already known, and therefore M-ary number M is calculated using equation (1) which is a formula, and Rₘₐₓ can be calculated using channel bandwidth W and the formula R=Wlog₂M.

$${P}_{e} \approx 2 Q [ \sqrt{2 SNR} sin \frac{π}{M} ] \\ Q ( x ) = \frac{1}{2} erfc ( \frac{x}{\sqrt{2}} ) \qquad ( 1 )$$

Where is erfc( ) an error function.

At the same time as decision of maximum transmission rate Rₘₐₓ, the rate is adjusted using multilevel modulation and different coding schemes.

The application layer then checks whether or not Rₘₐₓ is larger than bit rate R_{ch} of the current channel when the physical layer transmits one frame based on bit rate information R_{ch} of the current channel acquired by the physical layer (S25).

When Rₘₐₓ is less than bit rate R_{ch} of the current channel, the flow proceeds to step S27, and processing is complete.

When Rₘₐₓ is larger than bit rate R_{ch} of the current channel, the following processing is carried out.

In the case of using fine granularity scalability coding, transmission is started from the base layer, and the bits are increased until the total bit rate for the video frame falls below Rₘₐₓ at the enhancement layer (S26). In the case of using SNR and spatial, or temporal scalability, if Rₘₐₓ is large enough to accommodate the base layer and the enhancement layer at the same time, both layers are transmitted, but if Rₘₐₓ is not large enough, only the base layer is transmitted (S27).

Similarly, a cross layer joint setting method of the present invention can also be applied to a mono antenna OFDM wireless multimedia communication system, and multi-user, mono/multi-antenna OFDM wireless multimedia communication system.

As described above, the present invention is described using a typical embodiment. However, it is clear to one skilled in the art that various modifications, substitutions and additions are possible without deviating from the concept and scope of the present invention.

### INDUSTRIAL APPLICABILITY

The wireless multimedia communication method according to the present invention is suitable for use in multi-antenna orthogonal frequency division multiplexing.

1. A wireless multimedia communication method comprising the steps of:
scalability coding a multimedia video stream and dividing the multimedia video stream into a base layer and an enhancement layer based on a specific scalable coding scheme;
determining at an application layer whether or not a maximum transmission rate is larger than a current channel transmission rate upon transmission at a physical layer based on current channel transmission rate information acquired from the physical layer; and
when the maximum transmission rate is less than the current channel transmission rate, ending processing, and, when the maximum transmission rate is larger than the current channel transmission rate, and, when the specific scalable coding scheme is a first scalable coding scheme, starting transmission from the base layer and increasing bits at the enhancement layer until immediately after the current channel transmission rate of the video stream falls below the maximum transmission rate, and, when the specific scalable coding scheme is a second scalable coding scheme, and, if the maximum transmission rate can simultaneously accommodate the base layer and the enhancement layer, transmitting the base layer and the enhancement layer, and, if the maximum transmission rate cannot simultaneously accommodate the base layer and the enhancement layer, transmitting only the base layer.

2. The wireless multimedia communication method according to claim 1, wherein a signal to noise ratio for receiving antennas is calculated on a reception side where a plurality of antennas are provided, and the calculated signal to noise ratio is fed back to a transmission side using a feedback channel, and the transmission side decides a maximum transmission rate for the physical layer on the transmission side based on the signal to noise ratio information acquired at the feedback channel and a bit error rate required by a system.

3. The wireless multimedia communication method according to claim 2, wherein training sequences are transmitted from all antennas on the transmission side where the plurality of antennas are provided, and the signal to noise ratio is calculated using the training sequences received at the reception side.

4. The wireless multimedia communication method according to claim 2, wherein a coding scheme and modulation scheme of the physical layer change so as to match with rate requirements based on the channel transmission rate.

5. The wireless multimedia communication method according to claim 1, wherein the first scalable coding scheme is a fine granularity scalable coding scheme, and the second scalable coding scheme is a signal to noise ratio scalable coding scheme.

6. The wireless multimedia communication method according to claim 1, wherein the first scalable coding scheme is a fine granularity scalable coding scheme, and the second scalable coding scheme is a spatial scalable coding scheme.

7. The wireless multimedia communication method according to claim 1, wherein the first scalable coding scheme is a fine granularity scalable coding scheme, and the second scalable coding scheme is a temporal scalable coding scheme.

8. The wireless multimedia communication method according to claim 4, wherein a channel transmission rate is changed by changing the modulation scheme for the physical layer including MQAM and MPSK and changing the coding scheme for the physical layer including Turbo coding and low-density parity coding.
